(19) United States
(12) Patent Application Publication
(10) Pub. No.: US 2026/0063417 A1
(43) Pub. Date: Mar. 5, 2026

(54) DEBRIS DETERMINATION METHOD

(71) Applicant: SHIN-ETSU HANDOTAI CO., LTD., Tokyo (JP)

(72) Inventors: Masato OHNISHI, Nishigo-mura (JP); Masakazu SATO, Nishigo-mura (JP)

(73) Assignee: SHIN-ETSU HANDOTAI CO., LTD., Tokyo (JP)

(21) Appl. No.: 19/106,339

(22) PCT Filed: Aug. 7, 2023
(86) PCT No.: PCT/JP2023/028698

§ 371 Date: Feb. 25, 2025

(30) Foreign Application Priority Data
Sep. 12, 2022 (JP) 2022-144873

(51) Int. Cl. G01B 11/24; G01B 11/06

(52) U.S. Cl. CPC G01B 11/2441; G01B 11/06

(57) ABSTRACT

A debris determination method of determining presence or absence of debris occurrence around hard laser mark after hard laser mark is formed on a back surface of wafer or after back surface of wafer is polished after formation of hard laser mark, wherein thickness unevenness parameter of wafer is measured by flatness measuring instrument, and statistical data on thickness unevenness parameter of region including hard laser mark (referred to as region A) is extracted, along with statistical data on a thickness unevenness parameter of a region adjacent to the region A (referred to as region B) is extracted and statistical data of region A and statistical data of region B are compared and a difference is calculated, when the difference is equal to or greater than a predetermined threshold, debris is determined to occur. This provides debris determination method that can accurately detect a local thickness variation due to debris.

### TECHNICAL FIELD

The present invention relates to a debris determination method. In particular, the present invention relates to a debris determination method in a hard laser mark-formed region.

### BACKGROUND ART

In order to identify individual silicon wafers, there is a step of printing an individual number in a flat portion on an edge of a wafer using a solid-state laser (hard laser mark step (hereinafter, also referred to as HLM)). The hard laser mark is a dot line-shaped character formed by punching dots onto the wafer using a high-powered solid-state laser. The hard laser mark is printed at predetermined positions on a front and a back surfaces of the silicon wafer according to the SEMI standard.

Since physical properties of silicon around dot portions are transformed due to the high-power laser, the portions around the dots cannot be polished in a subsequent wafer polishing step in the same state as non-dot portions. Consequently, locally steep thickness rises (protrusions having heights from tens of nanometers to several micrometers) may be formed.

These rises are referred to as debris, and when the HLM is printed on the back surface, the debris occurs on the back surface; when a region including this debris is suctioned by wafer chucks during a device step, a shape of the debris may be transferred onto a device active surface (wafer front surface), causing defocus during exposure and significantly reducing device producing yields.

Therefore, it is necessary to detect in advance and screen the debris that occurred on the wafer back surfaces before the wafers are introduced into the device step.

As a method for detecting this debris, a method to use an optical interferometric flatness measuring instrument (WaferSight manufactured by KLA Corporation) is known, where, for example, presence or absence of the debris is determined based on magnitude of a value of ESFQR. However, flatness parameters of ESFQR only calculate difference between a maximum thickness and a minimum thickness in any region, and it is difficult to accurately detect the presence or absence of debris.

A reason for this is that, although this optical interferometric flatness measuring instrument has high measurement accuracy, dynamic range for a displacement amount is narrow. Consequently, when measuring the displacement amount at a location where the debris occurs, the dynamic range is easily exceeded, as a result, inaccurate values are included in measurement values which are treated as the maximum values and the minimum value for determining the ESFQR. Consequently, it is difficult to accurately detect the presence or absence of the debris by ESFQR which is provided by the optical interferometric flatness measuring instrument. Therefore, a conventional method for detecting the debris described above has a problem where the method cannot accurately classify the presence or absence of the occurrence of debris.

Another method for detecting the debris includes a method for evaluating the back surface of the wafer with high resolution using a laser microscope. However, this method does not provide sufficient throughput, and since it involves chucking the active surfaces of the devices, which results in destructive testing, thus, it cannot be adopted as a method for evaluating the debris in products.

Furthermore, Patent Documents 1 to 3 disclose arts as methods for evaluating the shapes of the wafer from perspectives different from ESFQR. These arts are methods aiming to quantify starting points of roll-off and flip-up, which represent peripheral shapes of the silicon wafers but these methods cannot detect local thickness variations such as debris. Moreover, it is preferable that the evaluation of the wafer shape is performed by excluding a 1 mm to 2 mm region from an outermost periphery and it is a prerequisite to obtaining shape data excluding the laser-marked portion.

### CITATION LIST

### Patent Literature

Patent Document 1: JP 2006-5164 A

Patent Document 2: JP 2004-20286 A

Patent Document 3: JP 2003-86646 A

### SUMMARY OF INVENTION

### Technical Problem

In an HLM printed region, debris may occur in which a shape around dots of a laser mark is steeply raised. To accurately measure a wafer flatness, it is preferable that a dynamic range of a flatness measuring instrument is narrow. However, when the dynamic range of the flatness measuring instrument is narrow, the measured value of debris rising steeply easily exceeds the dynamic range of the flatness measuring instrument.

For example, in measurement of a displacement amount using an optical interferometric measuring instrument; when a height difference exceeding approximately ¼ of wavelength (λ) of a light source being used occurs within a moving range of 1 mm, due to a principle of the optical interferometric measuring instrument, the interferometer is no longer able to accurately return the displacement amount corresponding to the actual displacement. Consequently, the HLM printed region where steep shape change occurs has been excluded from the region subject to flatness measurement.

In this case, when flatness including the HLM printed region is measured without excluding the HLM printed region by the flatness measuring instrument, the measured displacement amount cannot be measured accurately for the shape caused by debris that exceeds the dynamic range of the flatness measuring instrument and outputs thereof are either too large or too small.

Currently, presence or absence of the debris occurrence is confirmed using flatness parameters such as ESFQR for the region including the HLM printed region, without excluding the HLM printed region. A parameter referred to as site flatness such as ESFQR is expressed by difference (range) between a maximum value and minimum value of a designated region, even when a method of selecting a reference surface is different.

As with debris, when the shape change that exceeds the dynamic range of the flatness measuring instrument is measured, the displacement amount is output as either too large or too small, as described above. This value is often adopted as the maximum or minimum when calculating the site flatness. In other words, inaccurately measured values are treated as representative values for calculating the site flatness, resulting in the site flatness value being output as either too large or too small value.

As described above, conventionally, the flatness parameter such as ESFQR is used for the detection of the debris around the HLM (hard laser mark). Such a flatness parameter is calculated based on the difference between representative values such as the maximum value and the minimum value within any range. Therefore, a local shape change due to debris is masked by the shape change of the wafer thereof in the site, thus it is difficult to reveal the shape change being specific to the HLM printed region.

Furthermore, the steep shape change due to debris may exceed the dynamic range of the flatness measuring instrument; consequently, when calculating the site flatness such as ESFQR, the possibility is very high, in which inaccurate information exceeding the dynamic range is treated as the maximum value or the minimum value in the site.

In this way, the problem is that it is difficult to accurately detect the local thickness variation due to the debris.

The present invention has been made to solve the above-described problem. An object of the present invention is to provide a debris determination method that can accurately detect the local thickness variation due to the debris.

### Solution to Problem

To achieve the above object, the present invention provides a debris determination method of determining presence or absence of debris occurrence around a hard laser mark after the hard laser mark is formed on a back surface of a wafer or after the back surface of the wafer is polished after formation of the hard laser mark, wherein
a thickness unevenness parameter of the wafer is measured by a flatness measuring instrument, and then statistical data on the thickness unevenness parameter of a region including the hard laser mark (hereinafter referred to as a region A) is extracted, along with statistical data on a thickness unevenness parameter of a region adjacent to the region A (hereinafter referred to as a region B) is extracted and the statistical data of the region A and the statistical data of the region B are compared and a difference thereof is calculated, and when the difference is equal to or greater than a predetermined threshold, the debris is determined to occur.

Note that the thickness unevenness referred to here is, for example, a variation in thickness measured at a plurality of points.

With such a debris determination method, it is possible to detect the debris by separating an HLM printed region and another region to calculate the statistical values of each thickness data (for example, mean value, and standard deviation) and by comparing both values, thereby accurately detecting a local thickness variation due to the debris.

In detail, a part where the flatness measuring instrument outputs too large or too small value is limited to the vicinity of a center of HLM dots, considering a dot size (diameter of 50 μm) of the HLM. In addition, as an increase of the debris region, the region increases in which the measurement value exceeds a dynamic range of the flatness measuring instrument; accordingly, the displacement amount is accurately measured in the dynamic range and an area where the displacement amount is large is also increased. Consequently, it is possible to determine presence or absence of the debris by capturing an amount of change of measurement value using an evaluation method in which the measurement value in this region is reflected. Specifically, instead of evaluating the debris using only limited representative values such as “maximum value” and “minimum value” as in ESFQR; by comparing the statistical values such as the mean value, a central value, and the standard deviation which are derived from all measurement values in the HLM printed region and similar statistical values of a displacement amount in the region where the HLM is not printed, the displacement amount can be accurately measured in the dynamic range and a change of the area where the displacement amount is large can be reflected. As a result of conceiving how to distinguish the presence or absence of a debris occurrence based on an amount of change of that statistical value, separating the HLM printed region and other regions, calculating the statistical values (such as the mean value, the standard deviation, and the central value) of each thickness data, and comparing both statistical values to distinguish the presence or absence of the debris, it is confirmed that it is possible to accurately distinguish therebetween.

In this case, the statistical data can be any of mean value, standard deviation, mode value, central value, or variance.

In this way, the statistical data of the region A and the statistical data of the region B are compared and a difference thereof is calculated, when the difference is equal to or greater than a predetermined threshold, the debris can be determined to occur.

In this case, the threshold can be determined based on the correlation between the difference between the statistical data of the region A and the statistical data of the region B and presence or absence of debris occurrence.

In this way, the statistical data of the region A and the statistical data of the region B are compared, and a difference thereof is calculated, when the difference is equal to or greater than a predetermined threshold, the debris can be determined to occur.

In this case, in a region inner from the region A on the wafer (hereinafter referred to as a region C), a least-squares plane can be determined using thickness data at three or more points, and the thickness unevenness parameter can be then normalized, thereby determining the difference between the statistical data of the region A and the statistical data of the region B.

In this way, the statistical data of the region A and the statistical data of the region B are compared, and a difference thereof is calculated, when the difference is equal to or greater than a predetermined threshold, the debris is more accurately determined to occur.

In this case, a portion where the hard laser mark is formed can be defined as a portion along the outer periphery of a back surface of the wafer, and the region B can be defined as a region adjacent to the region A in a peripheral direction.

In this way, it is possible to accurately determine the presence or absence of the debris occurrence in the HLM, such as an individual number for identifying an individual silicon wafer.

### Advantageous Effects of Invention

As described above, according to the inventive debris determination method, the local thickness variation due to the debris can be accurately detected.

In detail, while the evaluation method using ESFQR cannot obtain the correlation between ESFQR and the displacement amount of the debris, the present invention enables accurate determination of the presence or absence of the debris by comparing the statistical value of the thickness at the hard laser mark portion with the statistical value of the thickness at other portions and assessing the variation in these values.

As a result, this makes possible the prevention of the release of wafers, in which the debris has occurred, to customers.

### BRIEF DESCRIPTION OF DRAWINGS

FIG. 1 is a view illustrating an example of a HLM print location.

FIG. 2 is a flowchart diagram illustrating an example of a calculation procedure for thickness unevenness (debris) around HLM.

FIG. 3 is an explanatory diagram illustrating a partial example of a calculation procedure for thickness unevenness (debris) around HLM.

FIG. 4 is a view illustrating an example in Example of a calculation procedure for thickness unevenness (debris) around HLM, which is a view illustrating STEPs 1 to 4 and a view illustrating “evaluation region and comparison region coordinates when Notch is set to the origin=(0, 0)”.

FIG. 5 is a view of STEPs 1 to 4 when normalized and when not normalized.

FIG. 6 is a table showing a measurement result.

FIG. 7 is a graph showing a measurement result.

### DESCRIPTION OF EMBODIMENTS

Hereinafter, the present invention will be described in detail. However, the present invention is not limited thereto.

As described above, a debris determination method that can accurately detect a local thickness variation due to debris has been desired.

To solve the above problem, the present inventors have earnestly studied and found out that a debris determination method of determining presence or absence of debris occurrence around a hard laser mark after the hard laser mark is formed on a back surface of a wafer or after the back surface of the wafer is polished after formation of the hard laser mark, wherein
a thickness unevenness parameter of the wafer is measured by a flatness measuring instrument, and then statistical data on the thickness unevenness parameter of a region including the hard laser mark (hereinafter referred to as a region A) is extracted, along with statistical data on a thickness unevenness parameter of a region adjacent to the region A (hereinafter referred to as a region B) is extracted and the statistical data of the region A and the statistical data of the region B are compared and a difference thereof is calculated, and when the difference is equal to or greater than a predetermined threshold, the debris is determined to occur. By using this debris determination method, a local thickness variation due to the debris can be accurately detected. This finding has led to the completion of the present invention.

Hereinafter, the inventive debris determination method is described.

### Debris Determination Method

### (Forming HLM)

HLM is printed on the wafer which is cut out from a silicon single crystal to identify an individual. At this time, print conditions for OCR (Optical Character Reader) mark and T7 conform to SEMI standards.

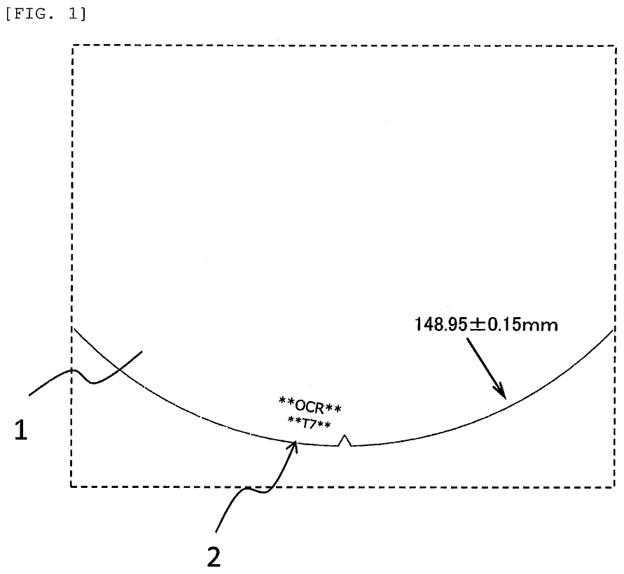

FIG. 1 shows an example of an HLM printed location when a hard laser mark 2 is printed on a wafer 1.

### (Polishing Wafer)

To the wafer that has been printed with the HLM, at least the surface provided with the HLM (usually, a back surface) is polished. Here, a double-sided polishing step can be performed.

### (Obtaining Wafer Thickness Data)

A wafer thickness data (front surface to back surface) is calculated from displacement amount data on both surfaces of the wafer using the flatness measuring instrument.

The flatness measuring instrument used in the present invention is not particularly limited as long as a target surface resolution is provided, and can be measured by using, for example, WaferSight 2 manufactured by KLA Corporation or an optical interferometric measuring instrument.

### (Extracting Thickness Data in HLM Region and Extracting Thickness Data Around HLM)

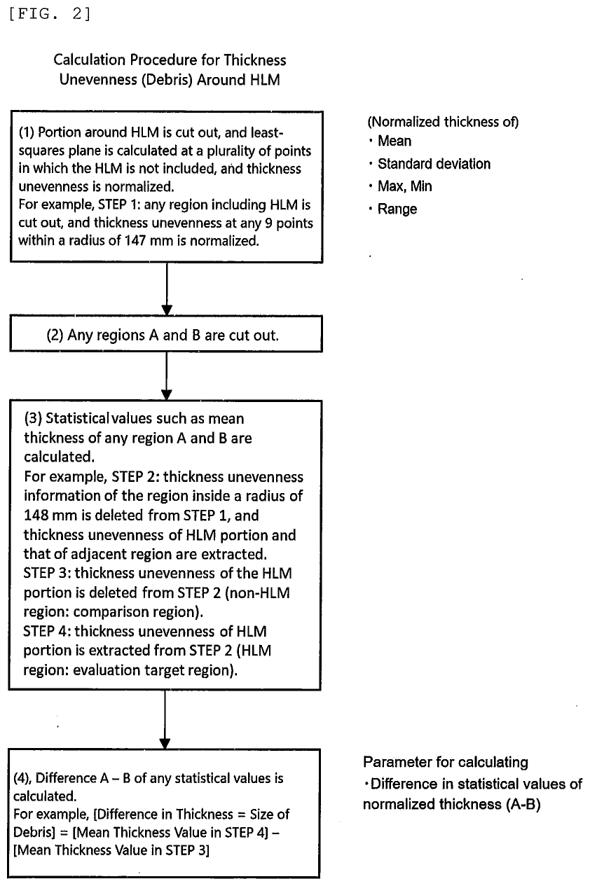

FIG. 2 is a flowchart diagram illustrating an example of a calculation procedure for thickness unevenness (debris) around HLM.

As shown in FIG. 2, the calculation procedure for the thickness unevenness (debris) around the HLM has steps (1) to (4).

In step (1), a portion around HLM is cut out, and a least-squares plane is calculated at a plurality of points in which the HLM is not included, and the thickness unevenness is then normalized. For example, STEP 1 is included. In STEP 1, any region including the HLM is cut out, and then, in the case of a wafer having a diameter of 300 mm, the thickness unevenness at any 9 points within a radius of 147 mm is normalized.

The reason for setting the normalized region to be inside the 147 mm is to exclude a thickness sag shape at a wafer periphery from the normalized region.

In step (2), any regions A and B are cut out.

In step (3), statistical values such as a mean thickness of any regions A and B are calculated. For example, STEPs 2 to 4 are included. In STEP 2, thickness unevenness information of the region inside a radius of 148 mm is deleted, and the thickness unevenness of the HLM portion and adjacent region is extracted. In STEP 3, the thickness unevenness of the HLM portion is deleted from STEP 2 (non-HLM region: comparison region). In STEP 4, the thickness unevenness of the HLM portion is extracted from STEP 2 (HLM region: evaluation target region).

Here, a reason to delete the region inside a radius of 148 mm is that, for example, when T7 of the HLM is used as an evaluation target, T7 is printed outside a radius of 148 mm.

In step (4), a difference in any statistical values A-B is calculated. For example, a formula is defined as follows.

$$[ Difference in Thickness = Size of Debris ] = [ Mean Thickness Value in STEP 4 ] - [ Mean Thickness Value in STEP 3 ]$$

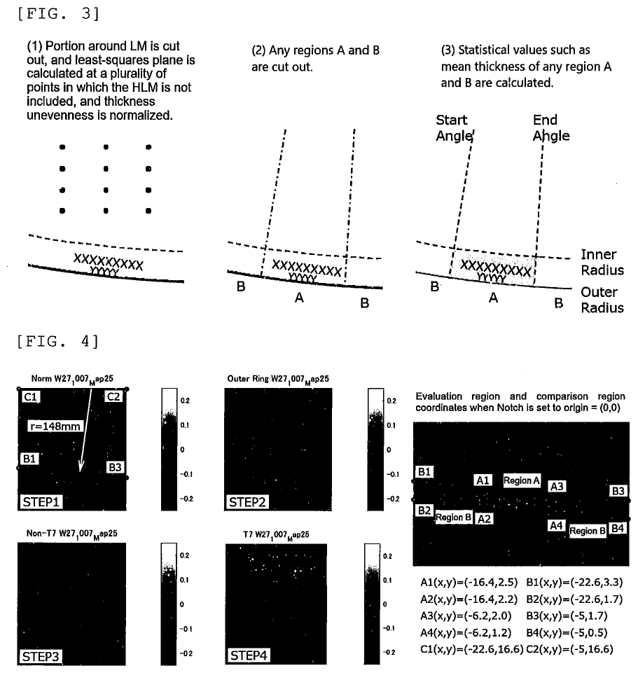

FIG. 3 is an explanatory diagram illustrating a partial example of a calculation procedure for the thickness unevenness (debris) around HIM. An example of steps (1) to (3) is shown. In step (1), any region including the HLM is cut out, and the thickness unevenness at any 12 points within a 147 mm radius is normalized. In step (2), any regions A and B are cut out. In step (3), the statistical value such as a mean thickness of any regions A and B is calculated.

### Step (1)

According to the procedure for calculating the thickness unevenness (debris) around the HLM, first, the thickness data around the laser mark is cut out from the wafer thickness data. The thickness unevenness of the cutout region is then normalized by calculating the least-squares plane using the thickness data (at least three points) of the inner region from the laser-marked region where the distance therebetween is about twice or more the distance from the wafer periphery to the laser marked region in the radial direction.

The upper limit of the number of the thickness data is not particularly limited but can be, for example, 100,000 or less.

### (Normalizing)

Note that the least-squares plane calculation calculated here is not necessarily essential. It is allowed to calculate the statistical values of the region A and the region B without normalizing. As shown in the formula below, the required statistical value can be calculated without calculating the least-squares plane.

$$[ Calculated Statistical Value ] = ( [ Shape Data of HLM printed region ] - [ Least - Squares Plane ] ) - ( [ Shape Data of portion without HLM ] - [ least - squares plane ] ) = [ Shape Data of HLM printed region ] - [ Shape Data of portion without HLM ]$$

However, when a thickness shape around HLM is simply cut out and the thickness data is drawn, the shape of the HLM printed region is buried in the thickness unevenness of the wafer itself, making it difficult to visually recognize the thickness shape unevenness around the HLM. In order to match information obtained from the calculation with visual information, it is preferable to calculate the least-squares plane from the cutout region and to normalize the thickness unevenness of the cutout region. By normalizing the cutout region, the HLM debris (raised portion: white on a gray scale) can be seen visually at ease (see FIG. 5).

### Step (2)

### (Calculating Statistical Value)

As shown in step (2) in FIG. 3, a boundary line is drawn at a print width of the laser mark, and the printed region (region A) and the non-printed region (region B) are divided. This boundary line can be drawn in either r-θ coordinate system or xy coordinate system. FIG. 3 is in the r-θ coordinate system.

### Step (3)

### (Calculating Statistical Value)

As shown in step (3) in FIG. 3, the statistical values such as the mean thickness of any regions A and B is calculated.

Here, the statistical value of the thicknesses of the A region and B region is any of mean value, standard deviation, mode value, central value, and variance. In this case, concerning a type of the statistical value, the same type of the statistical value is used for the statistical values of both the region A and the region B.

### Step (4)

### (Determining Presence or Absence of Debris)

The difference between the statistical value of the regions A and the statistical value of the regions B is calculated to quantify the relative size of the thickness unevenness around the laser mark (Difference=[Statistical Value A]−[Statistical Value B])

A predetermined threshold is provided for [Difference in Statistical Values]; when this threshold is exceeded, it is determined that the debris is present.

As for the threshold at this time, it is preferable to find a correlation in advance between the degree of the size of the debris and the statistical value and then set the threshold based on the size of the debris which is to be judged that the debris is present.

### EXAMPLE

Hereinafter, the present invention will be specifically described with reference to Example. However, the present invention is not limited thereto.

### Example 1

### (Providing Wafer)

Wafers having a diameter of 300 mm were provided in 12 pieces and were designated as Samples #1 to #12.

### (Forming HLM)

HLMs were printed on a back surface of each wafer at predetermined locations, and then the wafers were double-side polished.

### (Obtaining Wafer Thickness Data)

Measurements were performed using an optical interference type LNSW manufactured by KOBELCO research institute as a flatness measuring instrument.

FIG. 4 is a view illustrating an example of Example of a calculation procedure for thickness unevenness (debris) around HLM, which is a view illustrating STEPs 1 to 4 and a view illustrating “evaluation region and comparison region coordinates when Notch is set to the origin=(0, 0)”.

Specific ranges of “printed region=region A”, “non-printed region=region B” and “region C for calculating least-squares plane”, each defined in Example, will be described using a drawing of “evaluation region and comparison region coordinates when Notch is set to the origin=(0,0)” shown in FIG. 4 and a drawing of STEPs 1 to 4.

In Example shown in FIG. 4, a cutout region was the region bounded by x=(−22.6 mm to −5 mm), y=(0.5 mm to 16.6 mm) when the wafer was viewed from a back surface with a notch facing down, with the notch was set to an origin (0,0).

Subsequently, least-squares planes were calculated from any 9 points within a radius of 147 mm of the cutout regions, and thicknesses of the cutout region were normalized (see STEP 1 in FIG. 4).

Thickness data within a radius of 148 mm was deleted, and the thickness data in only arc-shaped regions that included HLM printed regions were cut out (see STEP 2 in FIG. 4).

The printed region=the region A was a region enclosed by connecting points A1 to A4 with lines. The non-printed region=the region B consisted of a region enclosed by connecting points B1 to B2 and A1 to A2 with lines and a region enclosed by connecting points A3 to A4 and B3 to B4 with lines.

Here, B1 to B2, A1 to A2, A3 to A4, and B3 to B4 were connected by straight lines, B1 to A1, A1 to A3, and A3 to B3 were connected by curves with a curvature of 148 mm, and B2 to A2, A2 to A4, and A4 to B4 were connected by curves with a curvature of 149.2 mm.

The region C for calculating the least-squares plane was a region cut out by lines connecting B1 to C1, C1 to C2, and C2 to B3, and by curves with a curvature of 148 mm connecting B1 to B3.

Here, each coordinate was; A1 (x, y)=(−16.4 mm, 2.5 mm), A2 (x, y)=(−16.4 mm, 2.2 mm), A3 (x, y)=(−6. 2 mm, 2.0 mm), A4 (x, y)=(−6.2 mm, 1.2 mm), B1 (x, y)=(−22.6mm, 3.3 mm), B2 (x, y)=(−22.6 mm, 1.7 mm), B3 (x, y)=(−5 mm, 1.7 mm), B4 (x, y)=(−5 mm, 0.5 mm), C1 (x, y)=(−22.6 mm, 16.6 mm), C2 (x, y)=(−5 mm, 16.6 mm).

The portion of the HLM printed region (about 10 mm in width) and a portion other than that region were separated (see STEPs 3 and 4 in FIG. 4).

### (Setting Threshold)

Based on information indicating a relation between an occurrence frequency of defocus reported by wafer users and production conditions, differences between mean thickness values of the region A and mean thickness values of the region B were calculated. Consequently, no product having a difference exceeding 0.01 μm was detected. Therefore, the threshold was set to 0.01 μm.

### (Calculating Statistical Value of Thickness Unevenness Parameter for Evaluation Target Sample, and Deciding to Pass or Fail)

Next, for 12 pieces of evaluation target samples, the regions A and the regions B were extracted in the same way as in the above, and the mean thicknesses of each of the region A and the region B were obtained, and then the differences between the mean thicknesses of the region A and those of region B were calculated.

Then, the wafers with a difference of less than 0.01 μm, being the threshold, were considered pass, and those with a difference of 0.01 μm or more were considered fail.

As a result, 9 wafers passed and 3 wafers failed.

### (Verifying Pass or Fail Decision)

To verify whether the pass or fail decision was correctly performed, the HLM printed region was measured using Ultrahigh Accurate 3D Profilometer (UA3P) manufactured by Panasonic Production Engineering Co., Ltd., which can directly measure surface displacement by destructive testing. Although all failed products were confirmed to rise in the HLM printed region, no rise was confirmed even in the HLM printed region of the passed products.

### (Examining Normalization)

Regarding Example 1, a case that was normalized and a case that was not normalized were compared and examined.

FIG. 5 is a view of STEPs 1 to 4 when normalized and when not normalized.

Regardless of whether normalized, the sizes of the HLM debris obtained by calculation showed no difference. However, when compared with the case that was not normalized, the case that was normalized revealed the rise in the HLM portion.

### Comparative Example 1

Evaluation target wafers of 12 pieces in Example 1 were used for measurements also by ESFQR.

The measurement conditions for ESFQR were as follows.

Measurement instrument: WaferSight 2+ manufactured by KLA Corporation
Edge exclusion: 2 mm
Number of sectors: 20 sectors
Sector length: 10 mm
Laser mark exclusion: none

### (Result of Measurement and Result of Pass or Fail)

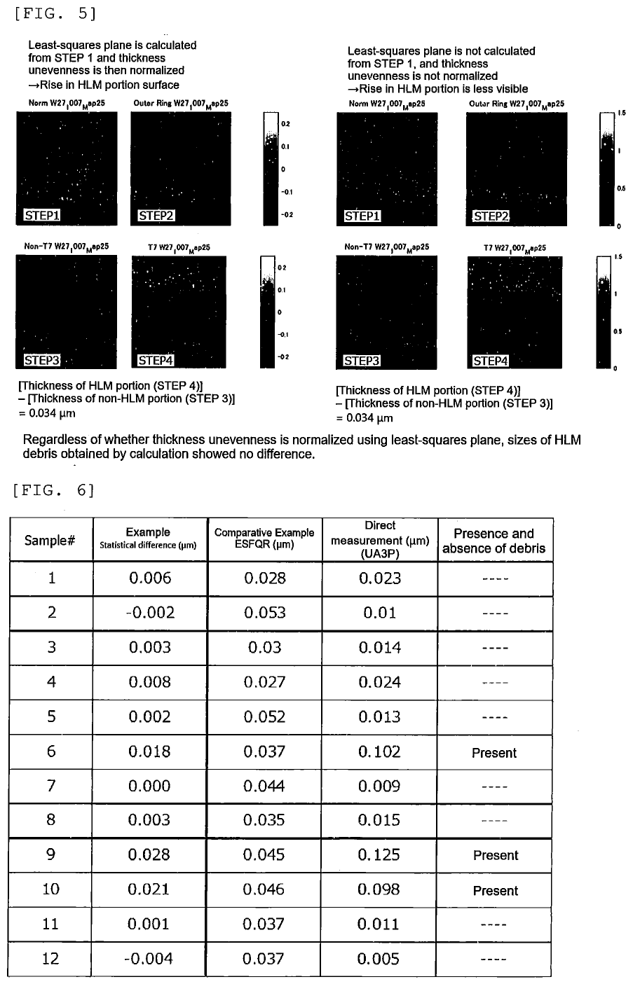

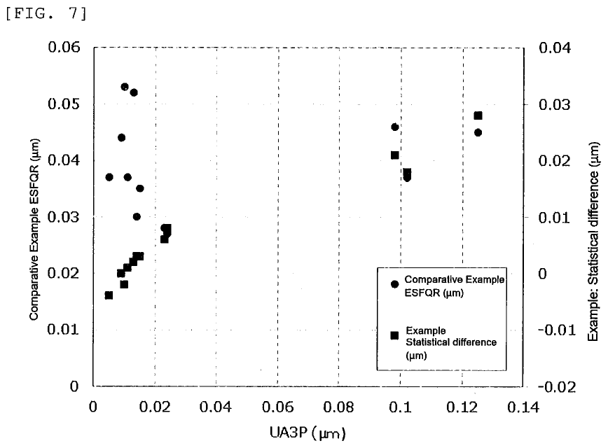

Before performing the destructive testing using UA3P against 12 pieces of the evaluation target wafers in Example 1, the measurements were performed under the above ESFQR conditions. FIG. 6 is a table showing a measurement result. FIG. 7 is a graph showing a measurement result. Correlation between the measurement result of the ESFQR and that of the UA3P in Example 1 was absent. It was found that the presence or absence of debris was unable to be determined from the ESFQR measurement.

As described above, according to Example of the present invention, a local thickness variation due to the debris was successfully detected accurately.

The present description includes the following embodiments.

[1]: A debris determination method of determining presence or absence of debris occurrence around a hard laser mark after the hard laser mark is formed on a back surface of a wafer or after the back surface of the wafer is polished after formation of the hard laser mark, wherein
a thickness unevenness parameter of the wafer is measured by a flatness measuring instrument, and then statistical data on the thickness unevenness parameter of a region including the hard laser mark (hereinafter referred to as a region A) is extracted, along with statistical data on a thickness unevenness parameter of a region adjacent to the region A (hereinafter referred to as a region B) is extracted and the statistical data of the region A and the statistical data of the region B are compared and a difference thereof is calculated, and when the difference is equal to or greater than a predetermined threshold, the debris is determined to occur.

[2]: The debris determination method according to [1], wherein
the statistical data is any of mean value, standard deviation, mode value, central value, or variance.

[3]: The debris determination method according to or [2], wherein
the threshold is determined based on the correlation between the difference between the statistical data of the region A and the statistical data of the region B and presence or absence of debris occurrence.

[4]: The debris determination method according to any of [1] to [3], wherein
in a region inner from the region A on the wafer (hereinafter referred to as a region C), a least-squares plane is determined using thickness data at three or more points, and the thickness unevenness parameter is then normalized, thereby determining the difference between the statistical data of the region A and the statistical data of the region B.

[5]: The debris determination method according to any of [1] to [4], wherein
a portion where the hard laser mark is formed is defined as a portion along the outer periphery of a back surface of the wafer, and the region B is defined as a region adjacent to the region A in a peripheral direction.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1. A debris determination method of determining presence or absence of debris occurrence around a hard laser mark after the hard laser mark is formed on a back surface of a wafer or after the back surface of the wafer is polished after formation of the hard laser mark, wherein
a thickness unevenness parameter of the wafer is measured by a flatness measuring instrument, and then statistical data on the thickness unevenness parameter of a region including the hard laser mark (hereinafter referred to as a region A) is extracted, along with statistical data on a thickness unevenness parameter of a region adjacent to the region A (hereinafter referred to as a region B) is extracted and the statistical data of the region A and the statistical data of the region B are compared and a difference thereof is calculated, and when the difference is equal to or greater than a predetermined threshold, the debris is determined to occur.

2. The debris determination method according to claim 1, wherein
the statistical data is any of mean value, standard deviation, mode value, central value, or variance.

3. The debris determination method according to claim 1, wherein
the threshold is determined based on the correlation between the difference between the statistical data of the region A and the statistical data of the region B and presence or absence of debris occurrence.

4. The debris determination method according to claim 2, wherein
in a region inner from the region A on the wafer (hereinafter referred to as a region C), a least-squares plane is determined using thickness data at three or more points, and the thickness unevenness parameter is then normalized, thereby determining the difference between the statistical data of the region A and the statistical data of the region B.

5. The debris determination method according to claim 1, wherein
a portion where the hard laser mark is formed is defined as a portion along the outer periphery of a back surface of the wafer, and the region B is defined as a region adjacent to the region A in a peripheral direction.

6. The debris determination method according to claim 2, wherein
in a region inner from the region A on the wafer (hereinafter referred to as a region C), a least-squares plane is determined using thickness data at three or more points, and the thickness unevenness parameter is then normalized, thereby determining the difference between the statistical data of the region A and the statistical data of the region B.

7. The debris determination method according to claim 1, wherein
a portion where the hard laser mark is formed is defined as a portion along the outer periphery of a back surface of the wafer, and the region B is defined as a region adjacent to the region A in a peripheral direction.

8. The debris determination method according to claim 2, wherein
a portion where the hard laser mark is formed is defined as a portion along the outer periphery of a back surface of the wafer, and the region B is defined as a region adjacent to the region A in a peripheral direction.
